(19) United States
(12) Patent Application Publication
(10) Pub. No.: US 2013/0204406 A1
(43) Pub. Date: Aug. 8, 2013

(54) CONTROL INTERFACE FOR HOUSEHOLD APPLIANCES

(71) Applicants: Mattias Andersson, Johanneshov (SE); Jerome Brasseur, Ulfsunda (SE); Petter Karlsson, Stockholm (SE)

(72) Inventors: Mattias Andersson, Johanneshov (SE); Jerome Brasseur, Ulfsunda (SE); Petter Karlsson, Stockholm (SE)

(73) Assignees: ELECTROLUX HOME PRODUCTS CORPORATION N.V., Brussel (BE); AKTIEBOLAGET ELECTROLUX, Stockholm (SE)

(21) Appl. No.: 13/639,133

(22) PCT Filed: Apr. 11, 2011
(86) PCT No.: PCT/EP11/55632

§ 371 Date: Jan. 18, 2013

(30) Foreign Application Priority Data
Apr. 12, 2010 (SE) 1000365-5

(51) Int. Cl. G05B 19/02

(52) U.S. Cl. CPC G05B 19/02
USPC 700/83

(57) ABSTRACT

A programmable user interaction control interface for household appliances such as ovens. The user interface comprises a display for displaying text and icons. The user interface further comprises control and selection buttons for navigation in a two dimensional menu structure. LED technology is used in order to lit up buttons as well as indicators.

### FIELD OF THE INVENTION

The present invention relates to user interaction interfaces, in particular it relates to a programmable control interface for household appliances.

### BACKGROUND OF THE INVENTION

Different types of user interfaces for household appliances have been around for several years. The last few years electronic user interfaces have become more popular. For example user interfaces having touch screens, or user interfaces having a display and a number of separate buttons and knobs that a user can use in order to input a program selection. The function of a user interface is of course dependent on what kind of household appliance the user interface is integrated in and also dependent on the context wherein it will be used. For example, a washing machine may have pre-programmed operation programs having specific temperature settings, whereas for kitchen appliance it may be possible to change a specific temperature also for pre-programmed operation programs.

When a user interacts with a household appliance via the user interface the arrangement of the different parts of the user interface is very important. A draw back with known user interaction interfaces is that they have not kept up with new technologies. Hence users may find it difficult to understand the menu systems of known user interfaces.

Furthermore there exist some other drawbacks with existing user interfaces. For example the user interfaces using buttons may take some time for a user to figure out. To understand the function of a specific button may be hard because the function of the button is not easily identifiable. This causes the setting or programming of a device to take more time than necessary.

### BRIEF DESCRIPTION OF THE INVENTION

Thus it is an object of the present invention to provide an improved user interface.

It is another object of the present invention to provide a user interface that facilitates faster navigation.

It is even a further object of the present invention to provide a user interface suitable for future generation users.

The above objects and others are achieved by a user interface according to the features in the appended claims.

According to a first aspect of the invention the above object and advantages are achieved by providing a programmable control interface for a household appliance, comprising predetermined operation programs, sub-operation programs and operation parameters arranged in a menu structure, the programmable control interface comprising: one or more horizontally arranged selection buttons for selecting an operation program, one or more control buttons for selecting a sub-operation program or for selecting an operation parameter, one execution button for execution of a selected selection, a display for displaying information associated with the selected selection, characterized in that the display displays at least a part of the menu structure.

Furthermore the horizontally arranged selection buttons moves at least a apart of the displayed part horizontally in the menu structure thereby a user can easily associate the position of the selection buttons with the movement in the menu structure.

The same is applicable to the control buttons that moves the displayed part of the menu structure vertically in the menu structure. Preferably the menu structure is a two dimensional menu structure wherein the user can navigate between the top level operation programs and in each top level operation program the user can navigate down a list of sub-operation programs and/or parameters. The user interface according to the present invention also facilitates direct switch from a sub-operation program level or operation parameter location to an operation program location in the menu structure.

A selected selection may comprise a selection of an operation program and/or a selection of a sub-operation program and/or a selection of an operation parameter.

The display is of such a type that it can display information comprising both text and icons associated with the selected selection. Furthermore the display may also display moving or animated icons and graphics.

Preferably at least a part of the selected selection is centered and/or vertically centered in the display. For example when a user selects a sub-operation program, the text and/or icons for that sub-operation program is close to vertically centred in the display. Preferably the text is displayed slightly above an imagined center line in the display, or above an imagined center line in a display field if the display is divided into different display field. An icon or text for an operation program may also be vertically centred similar to the text above, however it may also be displayed in another position in the display, such as in the top or bottom, thereby it is indicated to a user which operation program has been selected.

The control buttons may comprise a rotatable knob so that a user can scroll through the sub-operation programs and/or operation parameters by turning the rotatable knob. The rotatable knob may further comprises the execution button, either the whole rotatable knob can be pushed, or the centre portion of the rotatable knob may comprise the execution button so that by pushing the centre portion of the rotatable knob the execution button is pushed.

The control button may according to a first embodiment comprise two vertically arranged buttons so that a user can scroll through the sub-operation programs.

The menu structure is preferably a two dimensional menu structure comprising the operation programs arranged horizontally at the highest level in the menu structure. From each operation program, sub-operation programs and/or operation parameters are arranged vertically in the menu structure according to a list structure.

The display may comprise a colour display being able to display multiple colours. However according to a preferred embodiment only two colours are used. For example white and orange or white and green. The display can be divided into two or more display fields, one field can be used for displaying passive parts of the information and one field for displaying active parts. By active parts means information that the user can influence by for example using the control buttons and/or the selection buttons. Thus the displayed information may comprise one or more active parts and one or more passive parts.

In one of the operation programs a user is able to add additional sub-operation programs to the menu structure. Hereby the user can add a new setting suitable for a specific task that suits the user. When the user have added such a new setting the new setting will be added to the two dimensional menu structure and can there after be selected accordingly.

In order to facilitate the navigation for a user the display may also display a menu structure indicator associated with the sub-operation programs and/or operation parameters. By this feature it is easier for a user to understand what parts of the structure the current display displays.

In order to further enhance the graphicness of information, the display can be configured to increase brightness of the selected selection. Thus when the text and/or icons associated with a specific sub-operation program is selected and therefore vertically centred in the display, the brightness may be increased for this specific text and/or icon. Furthermore the display may also be configured to increase saturation of a selected selection. The other sub-operation programs and/or operation parameters visible above respectively under the selected sub-operation program and/or operation parameter are only visible but with lower brightness and/or saturation.

The operation programs according to the invention preferably comprises one or more of the following categories: temperature settings, operation functions, time settings, food probe, favourite settings, automatic cooking, cleaning, and settings. Thereby a user can easily navigate between these categories.

According to a second aspect of the present invention the above objects and others are achieved by an oven comprising a programmable control interface according to the first aspect of the present invention.

### BRIEF DESCRIPTION OF FIGURES

FIG. 1 illustrates a first embodiment of a user interface according to the present invention.

FIG. 2 illustrates a second embodiment of a user interface according to the present invention.

FIG. 3 illustrates a third embodiment of a user interface according to the present invention.

FIG. 4 illustrates a two dimensional menu structure.

FIG. 5 to FIG. 12 illustrate screen shots of the user interface according to the second embodiment.

FIG. 13 illustrates the back of the user interface comprising a micro computer.

FIG. 14 to FIG. 21 illustrate screen shots of the user interface according to the first embodiment.

FIG. 22 illustrates how a user interface according to the first embodiment can be implemented in a household appliance such as an oven.

FIG. 23 illustrates an oven comprising a user interface according to the second and third embodiment.

FIG. 24 to FIG. 27 illustrate interaction between a user and the user interface according to the first embodiment.

FIG. 28 and FIG. 29 illustrates interaction between a user and the user interface according to the second embodiment.

FIG. 30 illustrates interaction between a user and the user interface according to the third embodiment.

### DESCRIPTION OF PREFERRED EMBODIMENTS

The user interfaces according to the present invention are built up from different parts assembled into a user interface 1, 17, 18 can be installed in a household appliance such as an oven. The user interface comprises a display 5 that can either be a colour display or a monochromatic display. The displays 5 can be programmed and controlled by the use of a micro computer 19 that are arranged on the back side of the display.

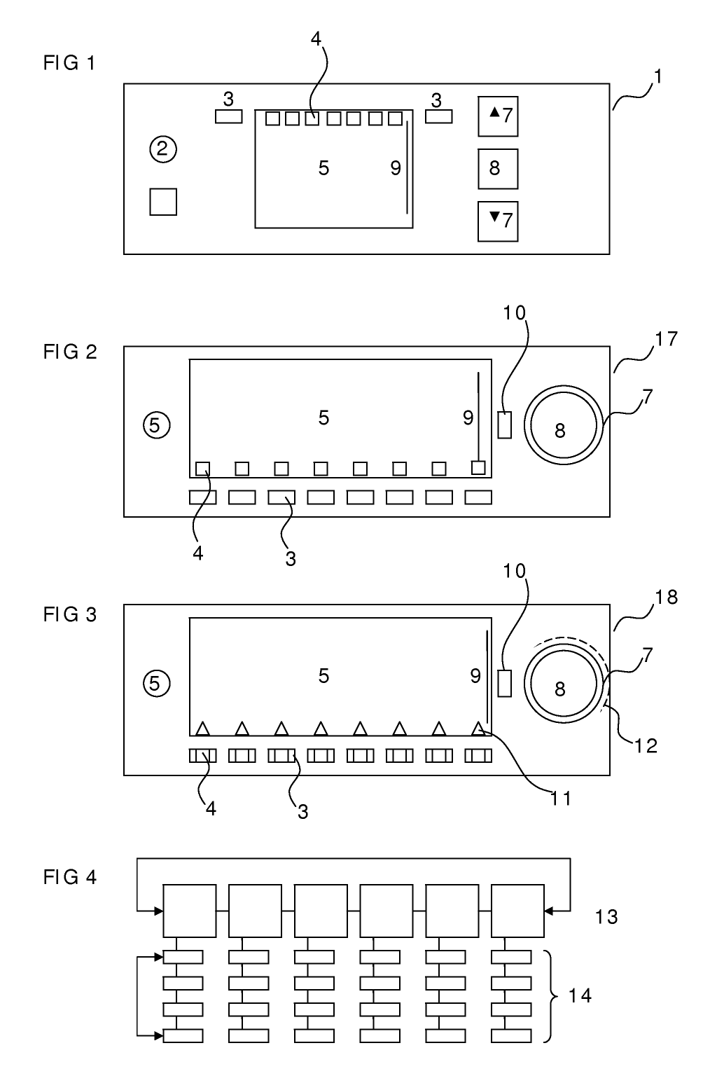

FIG. 1 illustrates a user interface 1 according to a first embodiment of the present invention. The user interface 1 comprises a display 5, selection buttons 3 for selecting an operation program, control buttons 7 for selecting a sub-operation program or an operation parameter, an on/off button 2, an execution button 8 for executing a selected selection. The display may display icons 4 in the top part of the display, on the right hand side in the display is a menu structure indicator 9 for facilitating navigation in the menu structure. Furthermore the user interface 1 comprises a return/home button 6 which returns the displayed position in the menu structure to a predetermined position in the menu structure or moves the displayed position up one level to the operation program level. The selection buttons 3 are arranged in the vicinity of the top of the display 5, or in the vicinity of the bottom of the display 5, preferably one on each side of the display 5. The arrangement of the selection buttons 3 is preferably related to the location of the icons 4 in the display 5, so if the icons 4 are arranged in the top part of the display 5, so are the selection buttons 3. The control buttons 7 is vertically arranged to the right of the display. However they could also be arranged to the left of the display. The execution button 8 is arranged in between the two control buttons 7. The reason for this arrangement of buttons is that this arrangement provides the shortest path, since the movement pattern of a user usually is to use the selection buttons 3, thereafter the user moves his/her finger to the control buttons 7, and finally the user executes his/her selection by pressing the execution button 8. By the present arrangement of buttons the user will have the shortest path with regards to travelled distance of his/her hand.

FIG. 2 illustrates a user interface 17 according to a second embodiment of the present invention. Similar to the first embodiment the second embodiment also comprises a display 5, an on/off button 2, selection buttons 3 for selecting an operation program, a return/home button 10 which returns the displayed position in the menu structure to a predetermined position in the menu structure or moves the displayed position up one level to the operation program level. The selection buttons 3 are arranged outside and below the display 5. Associated with each selection button is an icon 4 so that a user can immediately see and understand the function of that specific button. On the right hand side of the display the control button 7 is arranged, according to this embodiment the control button comprises a rotatable knob. The execution button 8 may either be located in the centre of the control button 7, but it could also be that the whole control button 7 also can be pushed, hereby the control button in this embodiment comprises two control motions, turning for selecting a sub-operation program or operation parameter and pushing for executing a selected selection.

FIG. 3 illustrates a user interface according to a third embodiment of the present invention. The third embodiment only differs from the second embodiment in FIG. 2 in that the icons 4 are arranged on the selection buttons 3 and instead the display displays an indicator 11 associated with the location of a pushed button so that a user can see which button has been pushed. Furthermore the user interface 18 comprises a status indicator 12 associated with the status of a function of the household appliance. For example the indicator is associated with the heat in an oven so that the status indicator 12 can display how far it is left until the selected temperature is reached. The status indicator may have a circular form and is lit up as the temperature increases. When the lit up part of the circle is closed it means that the selected temperature level is reached.

Preferably the user interfaces 1, 17, 18 uses LED technology as background light for lighting up the buttons 2, 3, 6, 7, 8, 10 and status indicator 12. The display may also be lit up by LED technology. Preferably white light is used.

FIG. 4 illustrates the menu structure that is used. Preferably the operation programs 13 are arranged in the highest level, each operation program 13 is associated with a list of sub-operation programs and/or operation parameters 14. The operation programs are categories that a user can select. Examples of categories are: temperature settings, operation functions, time settings, food probe, favourite settings, automatic cooking, cleaning, and settings. Thereby a user can easily navigate between these categories. Each of the above mentioned categories are associated with a sub-operation program 14 or operation parameter 14. For example the temperature setting category is associated with operation parameters that are temperature levels from 20° C. to 300° C. Whereas the time settings category is associated with sub-operation programs such as: set reminder, set and go, show duration, set delay and set end time and so forth. The arrows in FIG. 4 illustrates that a user can navigate from the position at the right hand side directly to the position on the left hand side in the operation program level. The same goes for the lists for the sub-operation programs and program parameters, here a user may be able to navigate directly from the lowest position to the highest position in the list without passing the sub-operation programs or program parameters in between. For some of the sub-operation program and/or program parameter list it may be meaningful not to have this function, however this is depending on the context wherein it is being used.

FIG. 5 illustrates a screen shot of a user interface 17, when the household appliance is turned off. In this status the user interface displays the time, also the on/off button 2 can be seen, as well as the selection button 3.

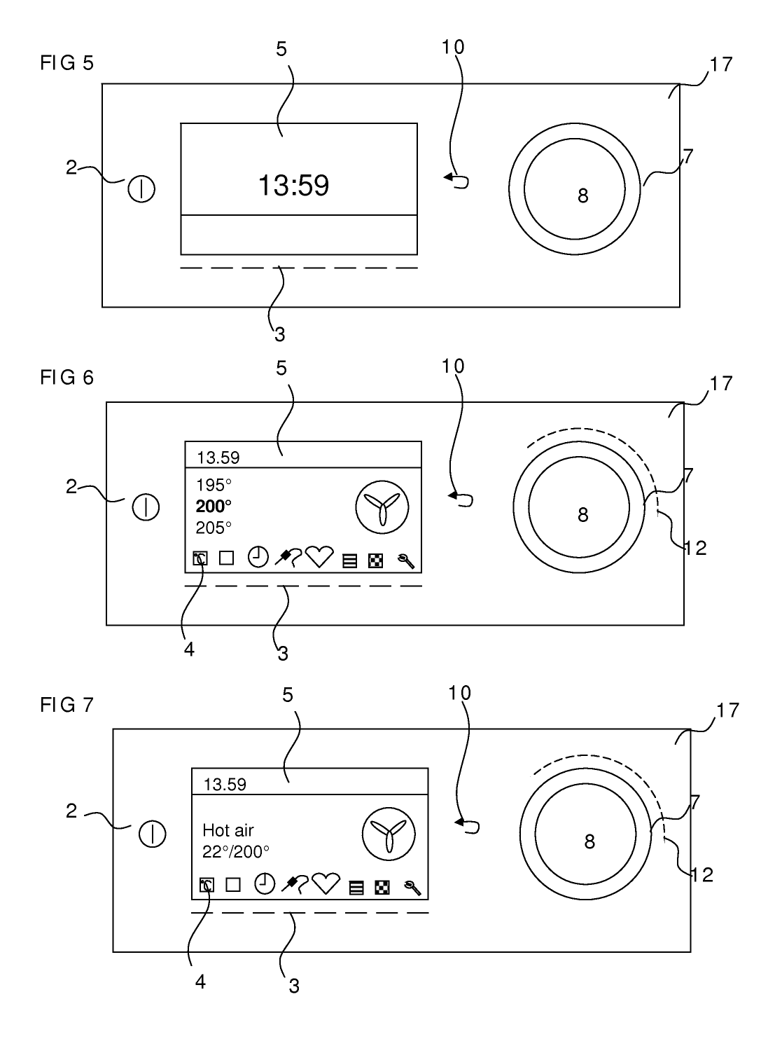

FIG. 6 illustrates a screen shot of a user interface 17, when the household appliance has been turned on. Here the user interface highlights the temperature icon in the lower left corner of the display and an icon is displayed illustrating a fan. Furthermore the operation parameters are displayed on the left side in the display. The icons associated with the operation programs that have not been selected have lower brightness compared to the selected temperature icon.

FIG. 7 illustrates a screen shot of a user interface 17, after a user have pushed the execution button 8. Here it can be seen that the oven starts to warm up. The target temperature 200 can be seen on the right hand side and the current temperature is indicated in a different colour on the left hand side. The current temperature increases in steps of 1° C. or 5° C. until it reaches 200. The status indicator 12 illustrating the status can also be seen around the control knob 7.

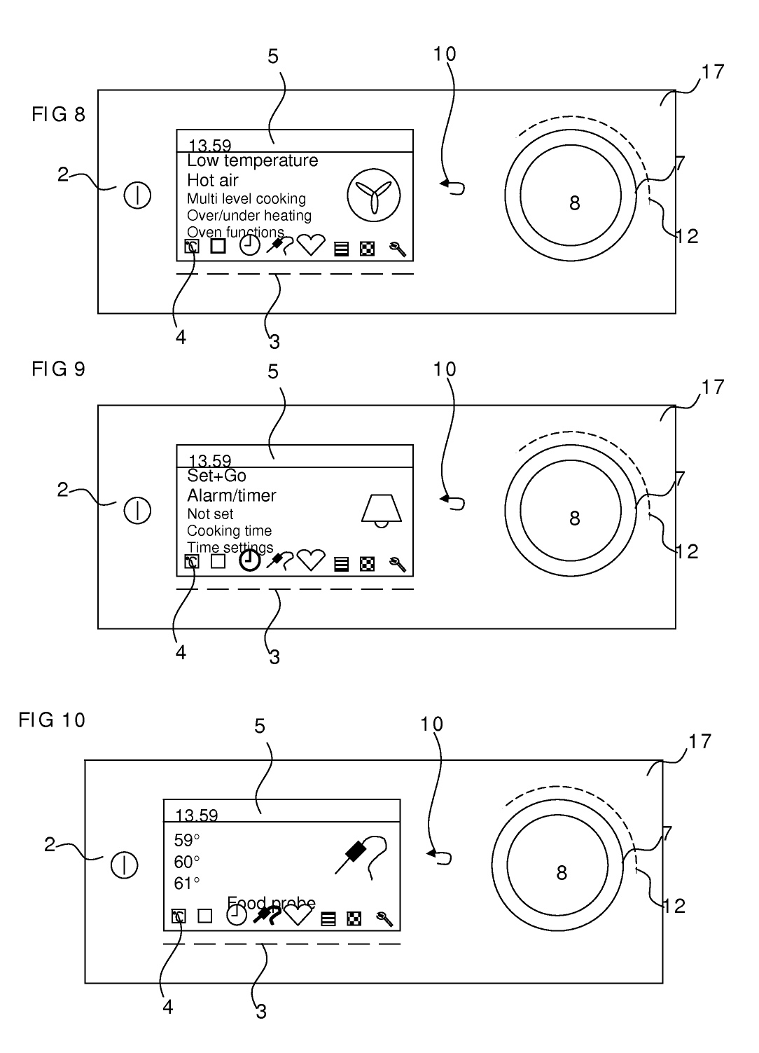

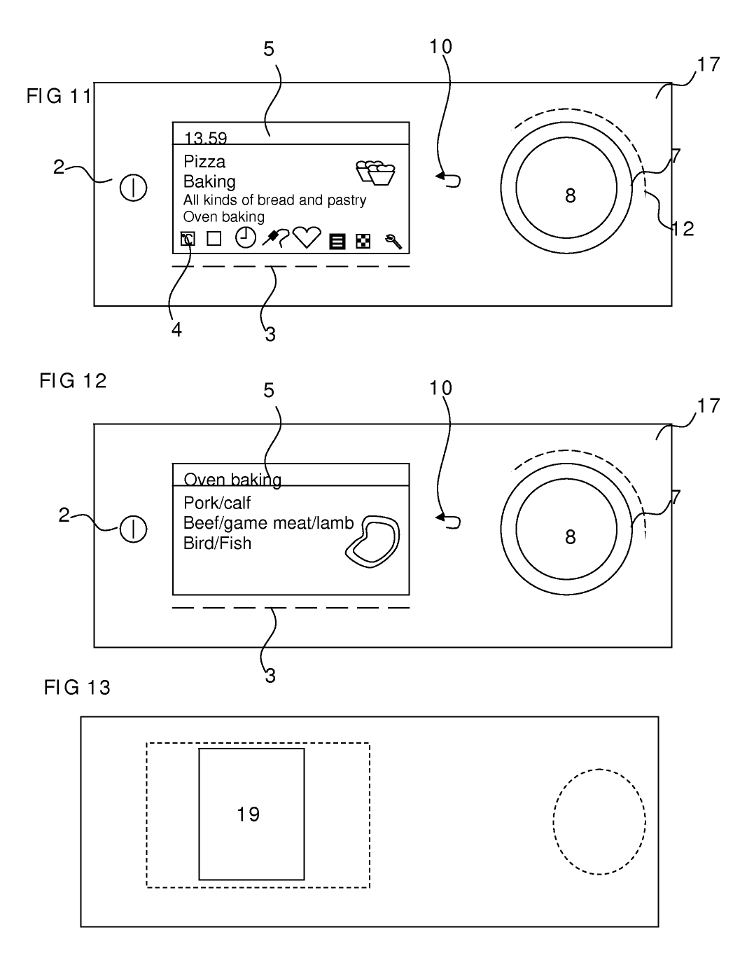

FIG. 8 to FIG. 12 illustrates screen shots of a user interface 17, after a user have selected other operation programs so that a different icon have increased brightness in the bottom of the display 5.

FIG. 13 illustrates the back side of a user interface, 1, 17, 18 disclosing a micro computer unit 19 whereby the user interface is controlled. The micro computer unit 19 is coupled to the buttons and display by wires not disclosed in the figure. Furthermore wires to a power source are connectable to the user interface in order to supply the user interface with energy. The micro computer 19 can receive input signal from the button. Furthermore it comprises a memory for storage of predetermined operation programs. Additional operation or sub-operation programs can be entered in the memory.

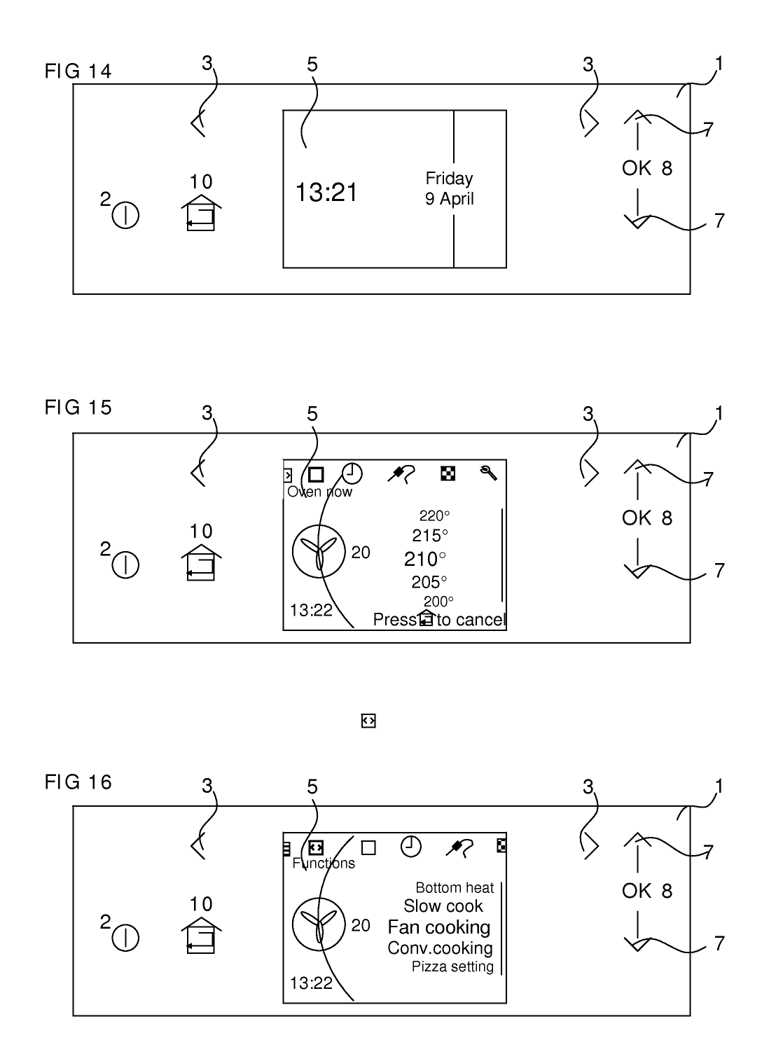

FIG. 14 illustrates a screen shot of a user interface 1, when the household appliance is turned off. In this status the user interface displays the time, also the on/off button 2 can be seen as well as the selection buttons 3, control buttons 7, home button 10 and execution button 8.

FIG. 15 illustrates a screen shot of a user interface 1, immediately after the household appliance has been turned on. Here the user interface highlights the temperature icon 4 in the upper right corner of the display 5 and a second icon 4 is displayed illustrating a fan. Furthermore the operation parameters are displayed arranged to the right in the display 5. The icons 4 associated with the operation programs 13, which have not been selected, are not as bright compared to the selected temperature icon 4.

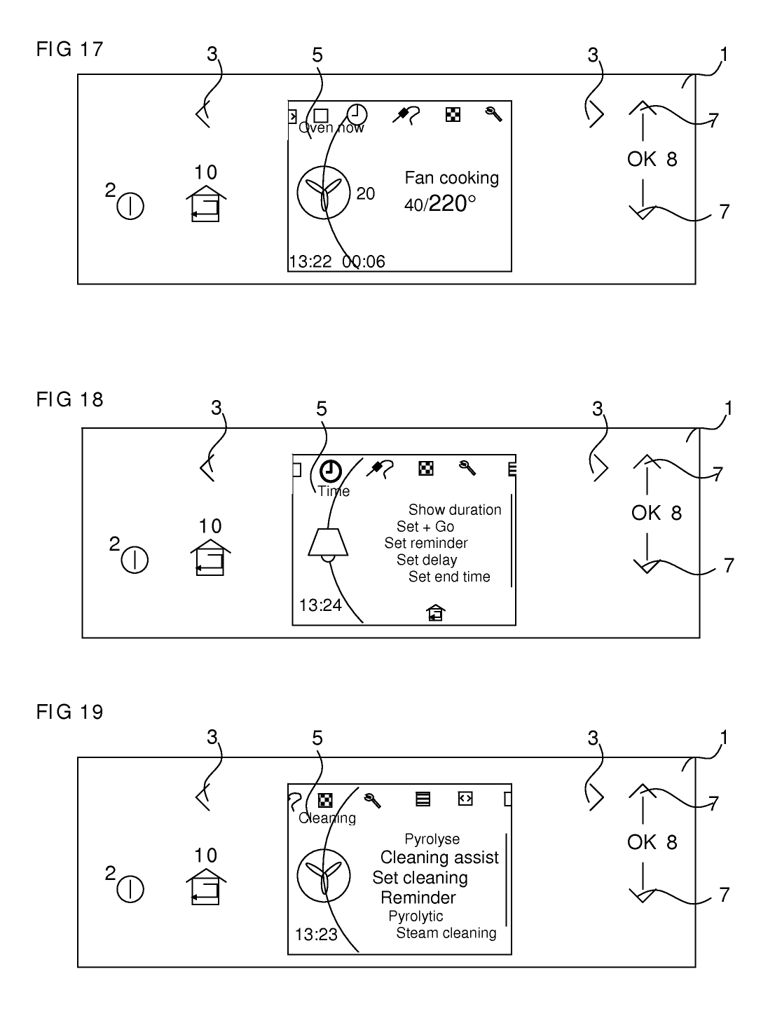

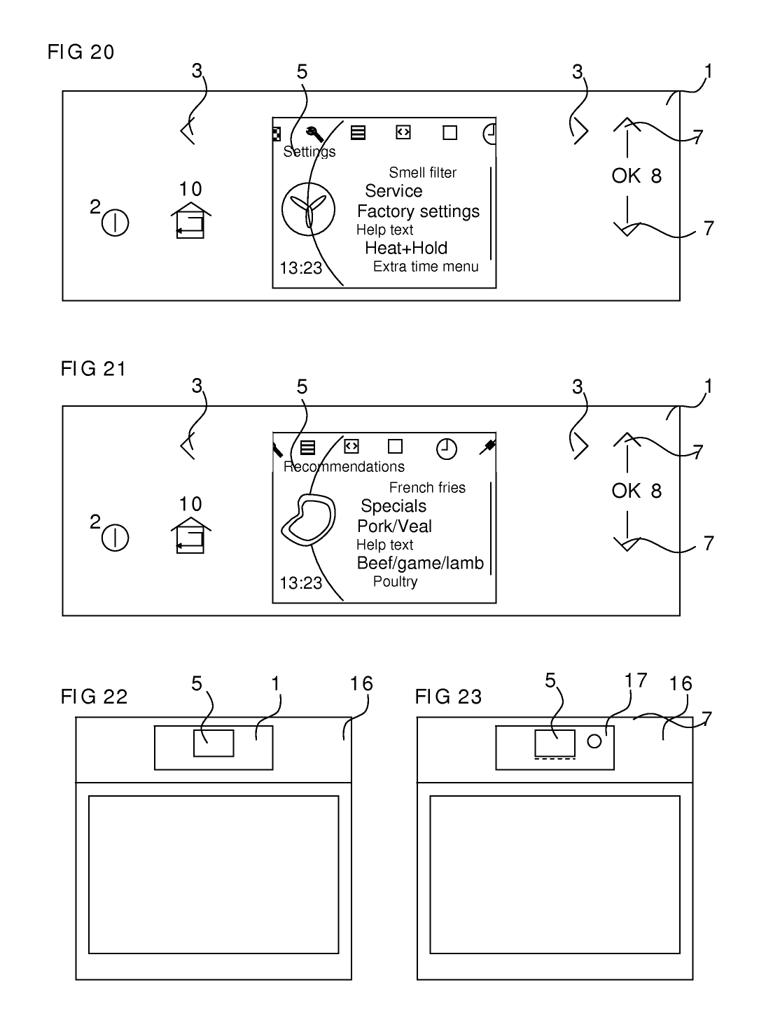

FIG. 15 to FIG. 21 illustrates screen shots of a user interface 1, after a user have selected other operation programs so that different icons 4 are lit up in the top of the display 5.

FIG. 22 illustrates an oven comprising a user interface 1 according to the first embodiment of the present invention

FIG. 23 illustrates an oven comprising a user interface according to the second and third embodiment of the present invention.

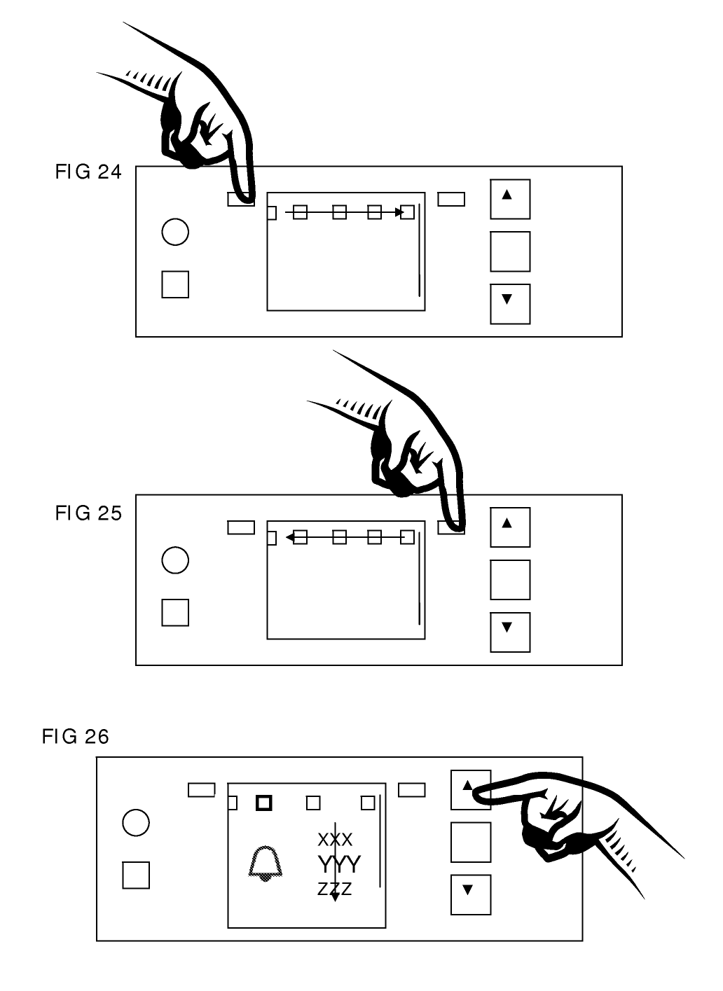

FIG. 24 illustrates navigation according to the first embodiment of the user interface 1. A user can press the selection buttons 3 with his/her finger. Upon pressing the selection buttons the display is programmed to scroll the icons 4 over the screen. When the user presses the selection button on the left side the icons moves from left to right on the display. In order for a user to see which the next icon is at least a part of the icon is displayed on the left hand side of the display 5.

FIG. 25 illustrates navigation according to the first embodiment of the user interface 1. Similar to the illustration in FIG. 24 the user can push the selection button 3 arranged to the right of the display 5. When the user presses this selection button the display is programmed to scroll the icons 4 from right to the left.

FIG. 26 illustrates navigation according to the first embodiment of the user interface 1. In this figure the user have selected an operation program 13 (Category) which is illustrated in that the icon 4 is bold in the figure.

Preferably this is indicated by increased brightness of the selected icon compared to the other icons. The user can now move on to selection of sub-operation programs and/or operation parameters by pushing one of the control buttons 7 on the right hand side of the display 5. By pressing the upper one of the control buttons 7 the text associated with the sub-operation programs and/or operation parameters moves from top to bottom in the display. As illustrated in the figure the selected text can be displayed using bigger font size compared to the surrounding text, and/or the selected text may also have increased brightness compared to the surrounding text, and/or the selected text may also be displayed in a different colour compared to the surrounding text or in any combination of the above. Preferably the selected text is displayed in white.

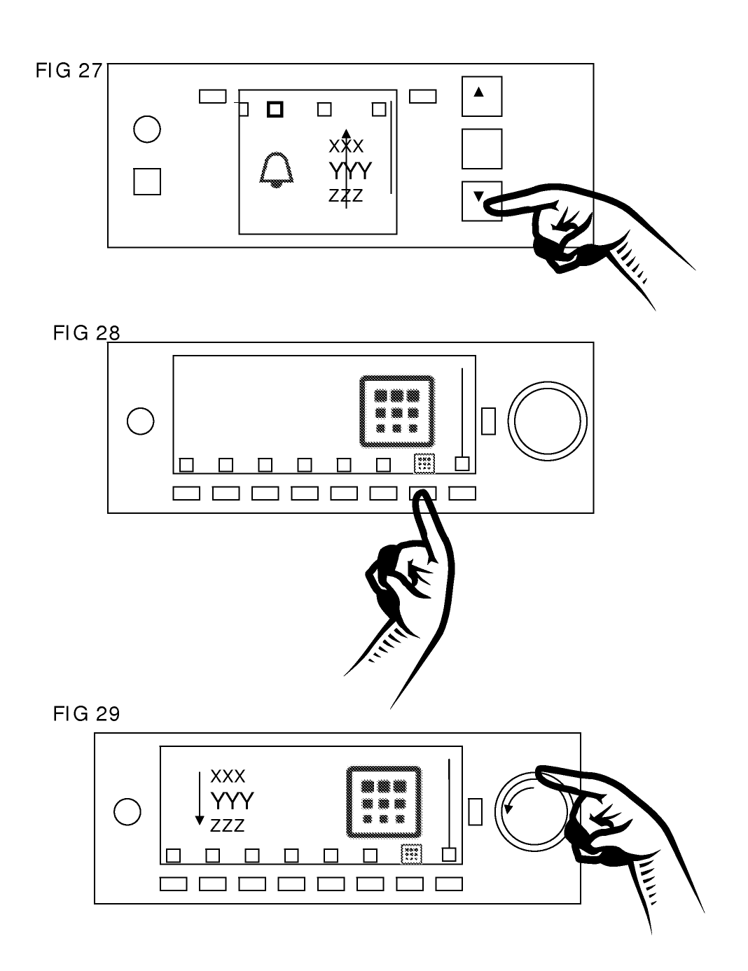

FIG. 27 illustrates navigation according to the first embodiment of the user interface 1. Similar to the illustration in FIG. 26 the user can press the lower control button 7, when doing this the text moves/scrolls from bottom to top in the display.

By using the navigation technique according to the present invention a user experiences that the display is moved around in the menu structure. Preferably two levels of the menu structure are displayed in the display 5. For example operation programs icons 4 are displayed in the top or bottom of the display and sub-operation programs and/or operation parameters are displayed vertically in the display, wherein a selection is displayed vertically centred in the display 5.

FIG. 28 illustrates navigation according to the second embodiment of the user interface 17. By pushing the selection buttons 3 associated with an icon 4 in the display the user can select an operation program (category). Either the brightness of the icon 4 associated with the pushed selection button 3 is increased, and/or the size and/or the colour and/or the position may be changed of the icon 4, so that a user can see which button that has been pushed. Furthermore an enlargement of the icon 4 may be displayed on the right hand side of the display.

FIG. 29 illustrates navigation after the user has selected an operation program as illustrated in FIG. 28. The user can select sub-operation program and/or operation parameter by turning the control button 7 on the right hand side so that the text associated with the sub-operation programs and/or operation parameters are moved/scrolled from bottom to top or the other way around. When a selection is made the user can press the execution button in order to execute his/her selection.

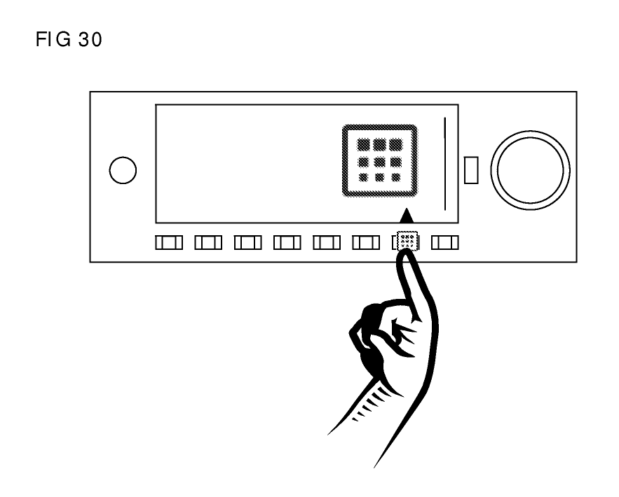

FIG. 30 illustrates navigation according to the third embodiment of the user interface 18. According to the third embodiment the icon 4 is displayed on the selection buttons 3 having a back light so that the icons can be lit up. The brightness of the pushed button can be increased in order to indicate which operation program has been selected to the user. In order to further enhance clarity an indicator 11 can be displayed in the display above the button associated with the selected operation program. For selection of sub-operation programs and/or operation parameters the navigation is similar to the navigation illustrated in FIG. 29.

The present invention is also applicable to other household devices such as dishwashing machines, Laundry machines, refrigerators and so forth.

For example a programmable control interface according to the present invention for a refrigerator or freezer could comprise operation programs such as modes, set cavity temperatures and feature access.

For the operation program modes the user could for example select between: vacation/holiday, super freeze, shopping and eco.

For the operation program set cavity temperature the user could for example select the temperature for each compartment if it is a multi compartment refrigerator or freezer.

For the operation program feature access a user could for example select bottle chill timer

In another example the present invention could also be applicable to laundry machines. In this case the operation programs could comprise, fabric programs for specific fabrics, time manager settings, temperature, spin speed of the drum, options, and delay start.

For the fabric program the sub operation programs or parameters could comprise cottons, synthetic, Delicates, eco, and time manager.

For the temperature operation program the desired temperature could be selected.

For the spin speed the desired spin speed different from the default could be selected.

For the options operation program, options such as extra rinse, pre-wash, easy iron, steam and so forth could be selected.

For the delay operation program it could be selected how much later the machine should start.

If the invention were to be implemented for a coffee machine the following could be operation programs: Type of coffee, taste, steam and options.

For the operation program type of coffee, the following could for example be selected: cappuccino, espresso, macchiato, jug, hot water.

For the operation program type taste the strength of coffee could be selected such as weak, medium and strong.

For the operation program options all options such as set language, set clock and so forth could be selected.

If the invention were to be used in the context of a dishwasher machine the following could be useful operations programs: dish program, time manager settings, delay start settings, options and favourites.

For dish programs the user could for example select sub-operation programs such as: intensive, delicate, eco, normal quick.

For delay start setting the user could select how much later in hours to start the machine,

For options the user could select between the options such as set language, set clock and so forth.

For Favourites the user could select programs (including settings) that has been defined as favourites by the user.

Hence the user would be able to create favourite programs that he/she can select.

In the above description the term “comprising” does not exclude other elements or steps and “a” or “an” does not exclude a plurality.

Furthermore the terms “include” and “contain” does not exclude other elements or steps.

1. A programmable control interface for a household appliance, comprising predetermined operation programs, sub-operation programs and operation parameters arranged in a menu structure, the programmable control interface comprising:
one or more horizontally arranged selection buttons for selecting an operation program,
one or more control buttons for selecting a sub-operation program or for selecting an operation parameter,
one execution button for execution of a selected selection,
a display for displaying information associated with the selected selection, characterized in that the display displays at least a part of the menu structure.

2. A programmable control interface according to claim 1 wherein the horizontally arranged selection buttons moves the displayed part horizontally in the menu structure,

3. A programmable control interface according to claim 1 wherein the control buttons moves the displayed part vertically in the menu structure.

4. A programmable control interface according to claim 1 wherein the menu structure is a two dimensional menu structure.

5. A programmable control interface according to claim 1 wherein the information comprises text and icons associated with the selected selection.

6. A programmable control interface according to claim 1 wherein at least a part of the selected selection is centered in the display.

7. A programmable control interface according to claim 1 wherein the control buttons comprises a rotatable knob.

8. A programmable control interface according to claim 1 wherein the rotatable knob comprises the execution button.

9. A programmable control interface according to claim 1 wherein the operation programs are arranged horizontally in the menu structure

10. A programmable control interface according to claim 1 wherein the sub-operation programs are arranged vertically in the menu structure.

11. A programmable control interface according to claim 1 wherein the operation parameters are arranged vertically in the menu structure.

12. A programmable control interface according to claim 1 wherein the displayed information is displayed in two colours.

13. A programmable control interface according to claim 1 wherein the displayed information comprises an active part and a passive part.

14. A programmable control interface according to claim 1 wherein additional sub-operation programs can be added to the menu structure.

15. A programmable control interface according to claim 1 wherein the display is configured to display moving graphics.

16. A programmable control interface according to claim 1 wherein the display further displays a menu structure indicator associated with the sub-operation program.

17. A programmable control interface according to claim 1 wherein the display is configured to increase brightness of a selected selection.

18. A programmable control interface according to claim 1 wherein the display is configured to increase saturation of a selected selection.

19. A programmable control interface according to claim 1 wherein the operation programs comprises one or more of the following categories:
temperature settings,
operation functions,
time settings,
food probe,
favourite settings,
automatic cooking,
cleaning, and
settings.

20. An oven comprising a programmable control interface according to claim 1.
